(19) United States
(12) Patent Application Publication
(10) Pub. No.: US 2023/0316761 A1
(43) Pub. Date: Oct. 5, 2023

(54) FRAUDULENT ACT DETECTION DEVICE AND FRAUDULENT ACT DETECTION METHOD

(71) Applicant: Toshiba Tec Kabushiki Kaisha, Tokyo (JP)

(72) Inventor: Masachika KURATA, Sunto Shizuoka (JP)

(21) Appl. No.: 18/175,146

(22) Filed: Feb. 27, 2023

(30) Foreign Application Priority Data
Mar. 24, 2022 (JP) 2022-048204

(51) Int. Cl. G06Q 20/40; G06V 20/52; G06V 20/40

(52) U.S. Cl. CPC G06V 20/52; G06Q 20/4016; G06V 20/44; G06V 2201/07

(57) ABSTRACT

According to one embodiment, a fraudulent act detection device includes a processor and a camera interface to connect to a camera positioned to acquire images of a purchaser at a settlement terminal. The processor is configured to recognize an action of the purchaser at the settlement terminal from an image acquired from the camera via the camera interface, acquire a degree of reliability for the recognition of the action of the purchaser, determine whether a change condition for changing a degree of reliability threshold has been met, set a value for the degree of reliability threshold based on whether or not the change condition has been met, and use the set value for the degree of reliability threshold in determining whether a fraudulent act of the purchaser has been recognized in acquired images of the purchaser at the settlement terminal.

### CROSS-REFERENCE TO RELATED APPLICATION

This application is based upon and claims the benefit of priority from Japanese Patent Application No. 2022-048204, filed Mar. 24, 2022, the entire contents of which are incorporated herein by reference.

### FIELD

Embodiments described herein relate generally to a fraudulent act detection device and a fraudulent act detection method.

### BACKGROUND

Retail stores such as supermarkets have been adopting a self-service POS (point of sales) terminal in view of the potential reductions in labor costs and as infection prevention measures or the like. Such a self-service POS terminal can be a full self-service-type settlement terminal at which the customer (purchaser) carries out all the operations from registration of merchandise to be purchased to settlement (payment) by himself or herself. Since a store clerk is not directly involved with such operations, a technique for monitoring actions of the purchaser at the self-service POS terminal, with a camera or the like, to detect possible fraudulent acts based on the movement of the purchasers hands or the like is desirable.

However, if the purchaser’s hand(s) enter a blind spot of the camera or the hand become invisible (undetectable) due to the state of the illumination (shadows or the like), actions of the purchaser might not always be correctly recognized. Thus, in some instances, due to action recognition results obtained with relatively low reliability, a normal act of the purchaser may be treated as a possible fraudulent act by mistake. Similarly, a fraudulent act of the purchaser may go undetected and be treated as a normal act by mistake.

### BRIEF DESCRIPTION OF THE DRAWINGS

FIG. 1 shows a system configuration in a store where a self-service POS terminal is introduced.

FIG. 2 is a schematic view showing a data structure of a member record.

FIG. 3 is a schematic view showing a display example of a monitoring image.

FIG. 4 explains the positional relationship between the self-service POS terminal and a camera.

FIG. 5 is a block diagram of a fraudulent act detection device.

FIG. 6 is a schematic view showing an example of the data structure of a first buffer.

FIG. 7 is a schematic view showing an example of the data structure of a second buffer.

FIG. 8 is a schematic view showing an example of the data structure of a threshold table.

FIG. 9 is a schematic view showing an example of the data structure of a threshold memory.

FIG. 10 is a flowchart for explaining functions of an action recognition section and a degree-of-reliability acquisition section.

FIG. 11 is a flowchart for explaining functions of an action recognition section and a degree-of-reliability acquisition section.

FIG. 12 is a flowchart for explaining functions of as an operation information acquisition section.

FIG. 13 is a flowchart for explaining functions of a condition detection section and a threshold decision section.

FIG. 14 is a flowchart for explaining functions of a fraud presumption section.

FIG. 15 is a flowchart for explaining functions of an output section.

FIG. 16 is a schematic view showing a first modification example of a threshold table.

FIG. 17 is a schematic view showing a second modification example of a threshold table.

### DETAILED DESCRIPTION

An embodiment described herein is to provide a fraudulent act detection device and a fraudulent act detection method that can properly indicate a possible fraudulent act of a purchaser in consideration of the degree of reliability of the action recognition.

In general, according to one embodiment, a fraudulent act detection device includes a processor and a camera interface to connect to a camera positioned to acquire images of a purchaser at a settlement terminal. The processor is configured to recognize an action of the purchaser at the settlement terminal from an image acquired from the camera via the camera interface, acquire a degree of reliability for the recognition of the action of the purchaser, determine whether a change condition for changing a degree of reliability threshold has been met, set a value for the degree of reliability threshold based on whether or not the change condition has been met, and use the set value for the degree of reliability threshold in determining whether a fraudulent act of the purchaser has been recognized in acquired images of the purchaser at the settlement terminal.

An example embodiment of a fraudulent act detection device will now be described using the drawings.

This example embodiment is configured to indicate a possible fraudulent act of a purchaser occurring at a self-service POS terminal. First, a system configuration in a store where self-service POS terminals are introduced will be described.

### Description of Store System

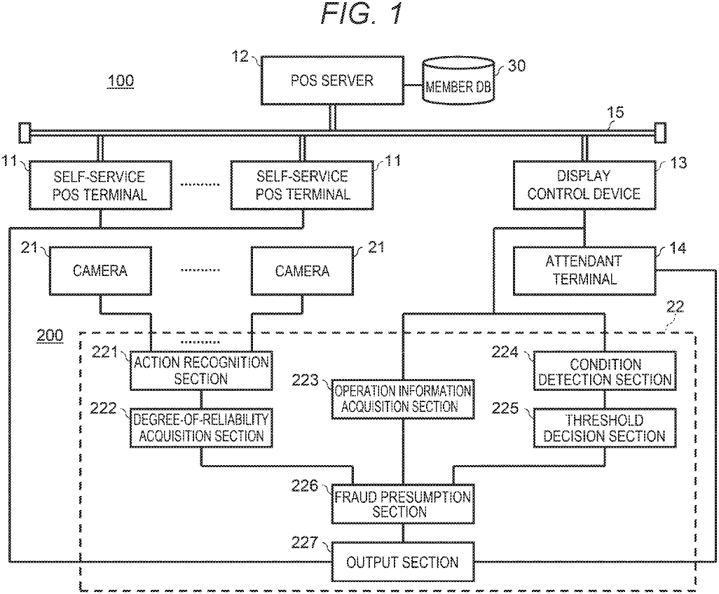

FIG. 1 shows a system configuration in a store where a self-service POS terminal 11 has been introduced. This system includes a self-service POS system 100 and a fraudulent act detection system 200. The self-service POS system 100 has a plurality of self-service POS terminals 11, a POS server 12, a display control device 13, an attendant terminal 14, and a communication network 15. The self-service POS terminals 11, the POS server 12, and the display control device 13 are connected to the communication network 15. The attendant terminal 14 is connected to the display control device 13. The communication network 15 is typically a LAN (local area network). The LAN may be a wired LAN or a wireless LAN.

The self-service POS terminal 11 is a full self-service-type settlement terminal at which a customer carries out, by himself or herself, operations from registration of an item of merchandise to be purchased to settlement. The purchaser (customer) operates an input device of the self-service POS terminal 11 and registers merchandise for purchase and then makes a payment (settlement) for the registered merchandise. The registration operation and the settlement operation for the merchandise are the same as those with existing devices are not described further here.

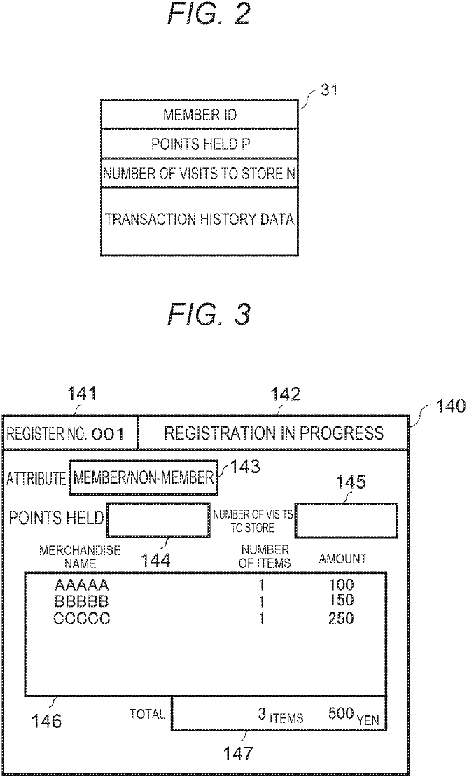

The POS server 12 is a server computer for centrally controlling the operation of each self-service POS terminal 11. The POS server 12 manages a member database 30. The member database 30 is an aggregate of member records 31 (see FIG. 2) for each registered member in a customer loyalty program (e.g., rewards point program) or the like. The member database 30 may be saved in a memory device built in the POS server 12 or may be saved in a memory device externally connected to the POS server 12.

FIG. 2 is a schematic view showing a data structure of each member record 31. The member record 31 includes items such as a member ID, points held P, number of visits to the store N, and transaction history data. The member ID is purchaser identification information for identifying an individual point member. A point member for a loyalty program of the store holds a “point card” on which information linked to his or her own member ID is recorded. Alternatively, the point member has installed an electronic money app (application software) that can display a barcode or a two-dimensional code that is linked to his or her member ID in a portable terminal such as a smartphone.

The points held P is a cumulative value of service points held by the point member. The point member is given service points by the store according to the number or value of sales transactions or the like. The point member cumulatively holds the service points and can use the service points to pay the price of merchandise or the like.

The number of visits to the store N is the number of times the point member has visited the store as a purchaser. The number of visits to the store N is, for example, a cumulative value over some predetermined period such as the last year or past three years from the current day taken as a reference point. The period may be any period of time. In some examples, the number of visits to the store N may be a cumulative value without any expiration or exclusion period.

The transaction history data is data of sales transactions completed at the store by the point member as the purchaser. The transaction history data includes data about the date and time of the transaction, data about the purchased merchandise, data about the payment method used for settlement, or the like.

Referring back to FIG. 1, the display control device 13 is a controller generating a monitoring image 140 for an attendant (see FIG. 3) based on a data signal output from each self-service POS terminal 11. The display control device 13 performs control in such a way that the monitoring image 140 is displayed on a display device of the attendant terminal 14. The attendant terminal 14 has a display such as a liquid crystal display or an organic EL display as the display device. The attendant terminal 14 is a terminal for a salesclerk, referred to in this context as an attendant, to monitor the state of each self-service POS terminal 11 based on the monitoring image 140. The attendant terminal 14 is an example of a salesclerk terminal. The attendant terminal 14 divides the screen of the display into a plurality of sections and displays the monitoring image 140 of each of the different self-service POS terminals 11 in a different section.

FIG. 3 is a schematic view showing a display example of the monitoring image 140 corresponding to one self-service POS terminal 11. As shown in FIG. 3, the monitoring image 140 includes a register number field 141, a terminal state field 142, an attribute information field 143, a points-held information field 144, a number-of-visits-to-store information field 145, a details field 146, and a total field 147.

The register number field 141 is a field for showing a register number. The register number is a serial number allocated to each self-service POS terminal 11 without duplication in order to identify each individual self-service POS terminal 11. The register number is identification information for identifying each self-service POS terminal 11.

The terminal state field 142 is a field for showing the present operation state of the self-service POS terminal 11. For example, one of “on standby”, “use started”, “registration in progress”, “settlement started”, and “settlement in progress” is shown as the operation state in the terminal state field 142.

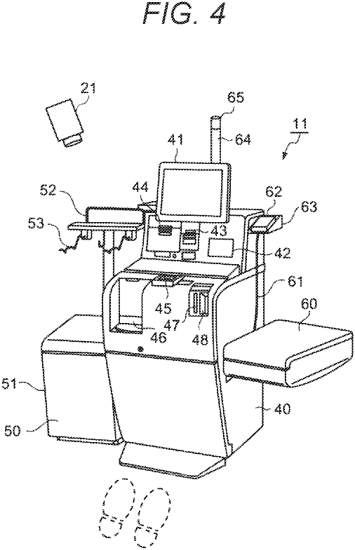

The “on standby” state is the state until the next purchaser declares the start of use after a previous purchaser finishes the settlement. An initial image is displayed on a touch panel 41 (see FIG. 4) of the self-service POS terminal 11 in the “on standby” state. The initial image is, for example, an image including a button for allowing the purchaser to select the use of a checkout bag provided by the store or the use of purchaser’s own bag.

The “use started” state is a state where a purchaser standing in front of the self-service POS terminal 11 has declared the start of use for settlement. For example, the purchaser performs a selection operation about whether to use a checkout bag or the purchaser’s own bag, on the initial image. The selection operation serves as the declaration of the start of use. In response to the selection operation, the operation state of the self-service POS terminal 11 turns into the “use started” state.

The “registration in progress” state is a state where a registration operation by the purchaser to register merchandise to be purchased is being accepted. When the first item of merchandise to be purchased is registered, the operation state of the self-service POS terminal 11 turns into the “registration in progress” state. Subsequently, the operation state of the self-service POS terminal 11 remains the “registration in progress” state until a shift to settlement is declared.

The “settlement started” state is a state where the purchaser has finished the registration of the merchandise to be purchased and declared a shift to settlement. A soft key for “payment” is displayed on the touch panel 41 of the self-service POS terminal 11 in the “registration in progress” state. The purchaser having finished the registration of the merchandise to be purchased touches the soft key for “payment”. This operation serves as the declaration of a shift to settlement. In response to this operation, the operation state of the self-service POS terminal 11 turns into the “settlement started” state.

The “settlement in progress” state is a state where a settlement process such as settlement by cash, settlement by electronic money, or settlement by credit card is being executed. For example, when a banknote or a coin has been inserted into a banknote insertion port 47 or a coin insertion port 45, the operation state of the self-service POS terminal 11 turns into the “settlement in progress” state. When the settlement process is finished, the operation state of the self-service POS terminal 11 returns to the “on standby” state.

The attribute information field 143 in this example is a field for showing information identifying whether the purchaser is a point member or not. The purchaser who is a point member inputs the member ID to the self-service POS terminal 11 before performing the selection operation about whether to use a checkout bag or the purchaser’s own bag on the initial image. For example, the purchaser holding a point card causes a card reader of the self-service POS terminal 11 to read the information on the point card. In some examples, the purchaser holding an information terminal in which an electronic money app that can display a barcode or a two-dimensional code linked to the member ID is installed causes a scanner of the self-service POS terminal 11 to scan the barcode or the two-dimensional code displayed on the information terminal. When the member ID is thus input to the self-service POS terminal 11, “member” is shown in the attribute information field 143 in response to a declaration operation to declare the start of use. If the declaration operation is performed without the input of a member ID, “non-member” is shown in the attribute information field 143.

The points-held information field 144 and the number-of-visits-to-store information field 145 are fields for showing the points held P and the number of visits to the store N, if the purchaser is a point member. If the purchaser is not a point member, the points-held information field 144 and the number-of-visits-to-store information field 145 are blank. Alternatively, the points-held information field 144 and the number-of-visits-to-store information field 145 are not shown.

The details field 146 is a field for showing details about the merchandise registered at the self-service POS terminal 11. The details information is, for example, a merchandise name, the number of items, and the unit price or the like. The total field 147 is a field for showing transaction total information regarding the merchandise registered by the purchaser at the self-service POS terminal 11. The total information is the total number of registered items, the total amount due for registered items, the amount of money inserted into the self-service POS terminal 11 for transaction settlement, the change due back to the purchaser, or the like. However, the configuration of the monitoring image 140 is not limited to the configuration shown in FIG. 3. Fields where other items are shown may be arranged in the monitoring image 140.

Referring back to FIG. 1, the fraudulent act detection system 200 includes a plurality of cameras 21 and a fraudulent act detection device 22. The plurality of cameras 21 correspond one-to-one to the plurality of self-service POS terminals 11. Each camera 21 is configured to capture an image of a customer (purchaser) operating the corresponding one of the self-service POS terminals 11.

The fraudulent act detection device 22 supports the plurality of self-service POS terminals 11. The fraudulent act detection device 22 functions as an action recognition section 221, a degree-of-reliability acquisition section 222, an operation information acquisition section 223, a condition detection section 224, a threshold decision section 225, a fraud presumption section 226, and an output section 227.

The action recognition section 221 has a function of recognizing an action of the purchaser at the full self-service-type settlement terminal (that is, the self-service POS terminal 11) based on captured image data output from each camera 21. The action recognition section 221 can be referred to as an action recognition unit. In this embodiment, the action recognition section 221 estimates the skeletal structure of joints of a person appearing in an image using an AI-based action recognition technology such as deep learning, and recognizes a take-out action and a bagging action of the purchaser based on the movement of the estimated skeletal structure.

Before explaining the take-out action and the bagging action, the positional relationship between the self-service POS terminal 11 and the camera 21 will be explained.

FIG. 4 explains the positional relationship between the self-service POS terminal 11 and the camera 21.

The self-service POS terminal 11 has a main body 40 on a floor and a bagging table 50 installed by the side of the main body 40. The touch panel 41 is attached at a top part of the main body 40. The touch panel 41 is formed of a display and a touch sensor. The touch panel 41 is an example of an input device. The display is a device for displaying various screens to an operator operating the self-service POS terminal 11. The touch sensor is a device for detecting a touch input on the screen by the operator. At the self-service POS terminal 11, the operator is usually a purchaser.

The main body 40 is provided with a basket table 60 on a side opposite to the side where the bagging table 50 is installed. The basket table 60 permits a purchaser to place a basket or the like containing items to be purchased. The purchaser carries out work standing in front of the main body 40 in FIG. 4 so as to be able to see the screen of the touch panel 41. Therefore, as viewed by the purchaser, the basket table 60 is on the right side of the main body 40 and the bagging table 50 is on the left side. The side where the purchaser stands is regarded as the front of the main body 40. The side where the bagging table 50 is installed is regarded as the left side of the main body 40. The side where the basket table 60 is provided is regarded as the right side of the main body 40. In other examples, the basket table 60 may be arranged on the left of the main body 40 and the bagging table 50 may be arranged on the right, as viewed by the purchaser.

The main body 40 has a scanner, a card reader, a printer, a change machine unit or the like built therein. At the front of the main body 40, a reading window 42 of the scanner, a card insertion port 43, a receipt dispensing port 44, the coin insertion port 45, a coin dispensing port 46, the banknote insertion port 47, and a banknote dispensing port 48 are located. The scanner is a device for scanning and reading a barcode or a two-dimensional code held in front of the reading window 42. The card reader is a device for reading information recorded on a card medium such as a point card or a credit card inserted into the card insertion port 43. The change machine unit is a device having a function of identifying the money type of a coin or a banknote inserted from the coin insertion port 45 or the banknote insertion port 47 and calculating the amount inserted, and a function of dispensing a coin or a banknote as change from the coin dispensing port 46 or the banknote dispensing port 48.

From the right side of the main body 40, a communication cable 61 extends outward. A reader-writer 62 for electronic money medium is connected to the distal end of the communication cable 61. The reader-writer 62 is placed on a stand 63 provided at a top part on the side right of the main body 40.

An indicator pole 64 is attached to the top side of the main body 40. The indicator pole 64 has a light-emitting section 65 at a distal end part thereof. The light-emitting section 65 selectively emits blue light or red light, for example. The indicator pole 64 indicates the state of the self-service POS terminal 11, for example, on standby, in operation, calling, error occurring, fraudulent act occurring, or the like, by the color of the light emitted from the light-emitting section 65. The indicator pole 64 may indicate the state of the self-service POS terminal 11 by flashing on and off the light-emitting section 65.

A bag holder 52 is attached to a top part of a housing 51. The bag holder 52 has a pair of holding arms 53. The holding arms 53 hold a checkout bag provided by the store or a shopping bag brought by the purchaser, that is, a so-called purchaser’s own bag, or the like.

The positional relationship between the self-service POS terminal 11 and the camera 21 will now be explained.

As shown in FIG. 4, the camera 21 is installed at a position where the camera 21 can capture, from above, an image of the purchaser standing in front of the self-service POS terminal 11 and facing components such as the main body 40, the bagging table 50, and the basket table 60.

First, the purchaser standing in front of the self-service POS terminal 11 places a basket or the like containing items to be purchased on the basket table 60 on the right side and causes the holding arms 53 on the left side to hold a checkout bag (or the purchaser’s own bag). Next, the purchaser operates the touch panel 41, following guidance displayed on the touch panel 41, and thus declares the start of use of the self-service POS terminal 11. The purchaser who is a point member inserts a point card (on which information linked to the purchaser’s own member ID is recorded) into the card insertion port 43 and causes the card reader to read the information on the point card after declaring the start of use. Alternatively, the purchaser holds a barcode or a two-dimensional code linked to the member ID displayed on an information terminal, such as a smartphone, over the reading window 42, and causes the scanner to read the barcode or the two-dimensional code.

Subsequently, the purchaser takes up by hand the items to be purchased one by one, from the basket placed on the basket table 60. If a barcode is attached to the item to be purchased, the purchaser holds the barcode over the reading window 42 and causes the scanner to read the barcode, and thus registers the item for purchase. If a barcode is not attached to the item to be purchased, the purchaser operates the touch panel 41 to select the item to be purchased from a list of merchandise without barcode, and thus registers the item. The purchaser puts the now-registered item into the checkout bag or the like.

The purchaser having finished the registration of all the items to be purchased operates the touch panel 41 to select a settlement method. For example, if the purchaser has selected settlement by cash, the purchaser next inserts a banknote or a coin into the banknote insertion port 47 or the coin insertion port 45 and then receives change dispensed from the banknote dispensing port 48 or the coin dispensing port 46 as necessary. If the purchaser has selected settlement by electronic money, the purchaser holds an electronic money medium over the reader-writer 62. If the purchaser has selected settlement by credit card, the purchaser inserts a credit card into the card insertion port 43. After finishing the settlement in this way, the purchaser receives a receipt dispensed from the receipt dispensing port 44 and leaves the store, taking the checkout bag (or the purchaser’s own bag) from the holding arms 53.

The camera 21 is installed at a position to capture an image of the movement of the hands of the purchaser acting as described above while in front of the self-service POS terminal 11.

Referring back to FIG. 1, the take-out action is an action of removing merchandise to be purchased from the basket on the basket table 60 and registering the merchandise to be purchased at the self-service POS terminal 11. For example, if a movement of the skeletal structure of one hand or both hands moving to the right side of the main body 40 and picking up and holding an item over the reading window 42 or operating of the touch panel 41 is detected, the action recognition section 221 recognizes that the take-out action has been carried out.

The bagging action is an action of putting an item for which registration has been finished into the checkout bag (or the purchaser’s own bag) at the bagging table 50. For example, if a movement of the skeletal structure of the hand that has carried out the take-out action moving to the left side of the main body and putting an item into the checkout bag is detected, the action recognition section 221 recognizes that the bagging action has been carried out.

The degree-of-reliability acquisition section 222 has a function of acquiring a degree of reliability for the action of the purchaser as recognized by the action recognition section 221. The degree-of-reliability acquisition section 222 can be referred to as a degree-of-reliability acquisition unit. If the movement of the skeletal structure of the hand of the purchaser at the self-service POS terminal 11 is detected without interruption by the action recognition section 221, the rate of recognition of the take-out action or the bagging action is high. However, for example, if the hand of the purchaser enters a blind spot of the camera 21 or the hand becomes invisible (undetectable) in the shade of an object due to the state of the illumination or the like and the detection of the movement of the skeletal structure is temporarily interrupted during the action recognition process, the rate of recognition of the take-out action or the bagging action drops. The degree-of-reliability acquisition section 222 acquires a calculated degree of reliability for the recognition of the take-out action or the bagging action, based on the rate of recognition of the take-out action or the bagging action as determined by the action recognition section 221.

The operation information acquisition section 223 acquires operation information of the purchaser at the self-service POS terminal 11. The operation information acquisition section 223 can be referred to as an operation information acquisition unit. The operation information acquisition section 223 acquires the monitoring image 140 controlled by the display control device 13 and acquires operation information about a use start operation, a merchandise registration operation, or a settlement start operation by the purchaser at the self-service POS terminal 11 from the information shown in the monitoring image 140.

Specifically, when “use started” is shown in the terminal state field 142 in the monitoring image 140, the operation information acquisition section 223 recognizes that a use start operation is carried out at the self-service POS terminal 11 identified by the register number shown in the register number field 141 in the monitoring image 140, and acquires operation information about the use start operation. When details information such as the merchandise name, the number of items, the amount or the like of the merchandise to be purchased is added into the details field 146 in the state where “registration in progress” is shown in the terminal state field 142 in the monitoring image 140, the operation information acquisition section 223 recognizes that a merchandise registration operation is being carried out at the self-service POS terminal 11 identified by the register number shown in the register number field 141 in the monitoring image 140, and acquires operation information about the merchandise registration operation. When what is shown in the terminal state field 142 in the monitoring image 140 changes to “settlement started”, the operation information acquisition section 223 recognizes that a settlement start operation has been carried out at the self-service POS terminal 11, and acquires operation information about the settlement start operation.

The condition detection section 224 has a function of detecting a change condition for the threshold for the degree of reliability. The condition detection section 224 can be referred as a condition detection unit. In this embodiment, a change condition is some attribute of the purchaser. Specifically, the change condition in this example is whether the purchaser is a point member or not along with whether the number of visits to the store N for the point member is a predetermined number or more. That is, whether the purchaser is a point member or a non-member is determined then, the number of visits to the store N for a point member is also considered.

The threshold decision section 225 has a function of setting a threshold for the degree of action detection reliability based whether or not a change condition is detected by the condition detection section 224. The threshold decision section 225 can be referred to as a threshold decision unit. The threshold decision section 225 sets the threshold to be higher or lower than a reference value according to the attribute(s) of the purchaser. Specifically, if the purchaser is considered to be a person with high reliability, the threshold decision section 225 sets the threshold to be higher than the reference value. If the purchaser is considered to be a person with low reliability based on some attribute(s) of the purchaser, the threshold decision section 225 sets the threshold to be lower than the reference value.

The fraud presumption section 226 has a function of indicating a fraudulent act of the purchaser based on the take-out action or the bagging action of the purchaser as recognized with the degree of reliability equal to or higher than the threshold decided by the threshold decision section 225. The fraud presumption section 226 detects a fraudulent act of the purchaser by taking the operation information of the purchaser at the self-service POS terminal 11 into account. The fraud presumption section 226 can also be referred to as a fraud detection unit. As described above, if the purchaser is considered to be a person with high reliability, the threshold is set higher than the reference value. That is, the fraud presumption section 226 indicates (detects) a fraudulent act of a purchaser based on the take-out action or the bagging action only when the detection has a higher degree of reliability than that corresponding to the reference value is met. Therefore, the criterion to detect a fraudulent act is higher for those persons considered to have higher reliability. Similarly, if the purchaser is considered to be a person with low reliability, the threshold is set lower than the reference value. That is, the fraud presumption section 226 detects (indicates) a fraudulent act of the purchaser based on the take-out action or the bagging action of a purchaser at a lower degree of recognition reliability than that corresponding to the reference value. Therefore, the criterion to detect a fraudulent act is lower for those persons considered to have lower reliability.

The output section 227 has a function of outputting the indication (detection) of a fraudulent act by the fraud presumption section 226. The output section 227 can also be referred to as an output unit. The output section 227 outputs the indication of a fraudulent act to at least one of the self-service POS terminal 11 where the presumed fraudulent act has taken place or the attendant terminal 14. In some cases, the output section 227 may output the indication of a fraudulent act to the POS server 12 or another device, such as an information communication terminal (such as a smartphone or a tablet terminal) carried by a salesclerk.

### Description of Configuration of Fraudulent Act Detection Device

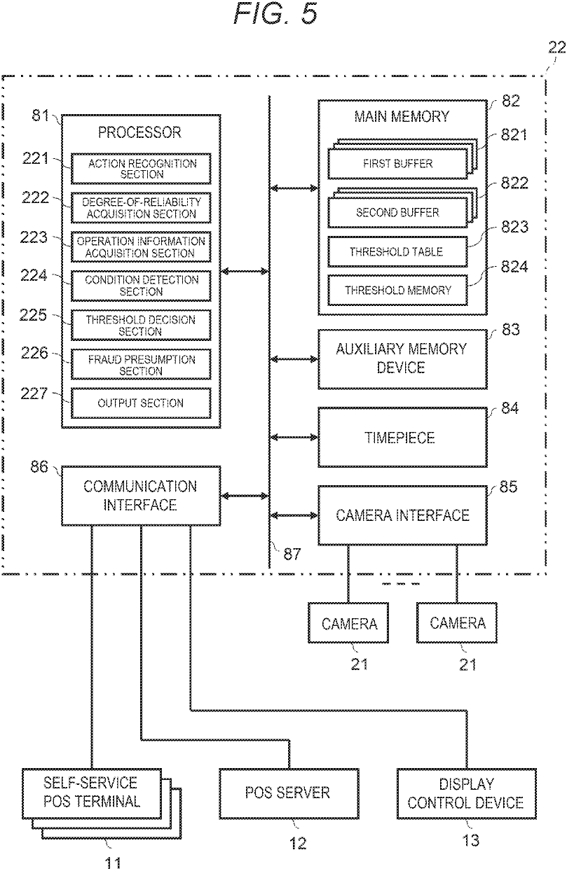

FIG. 5 is a block diagram of the fraudulent act detection device 22. The fraudulent act detection device 22 has a processor 81, a main memory 82, an auxiliary memory device 83, a timepiece 84 (clock), a camera interface 85, a communication interface 86, and a system bus 87. The system bus 87 includes an address bus, a data bus or the like. In the fraudulent act detection device 22, the processor 81, the main memory 82, the auxiliary memory device 83, the timepiece 84, the camera interface 85, and the communication interface 86 are connected via the system bus 87.

The processor 81 controls each part in order to implement various described functions of the fraudulent act detection device 22 according to an operating system or an application program. The processor 81 is, for example, a CPU (central processing unit).

The main memory 82 includes a non-volatile memory area and a volatile memory area. The main memory 82 stores an operating system or an application program in the non-volatile memory area. The main memory 82 stores data that is necessary for the processor 81 to execute processing to control each part, in the volatile memory area. In some cases, the data of this type may be stored in the non-volatile memory area. In the main memory 82, the volatile memory area is used as a work area where the processor 81 rewrites data according to need. The non-volatile memory area is, for example, a ROM (read-only memory). The volatile memory area is, for example, a RAM (random-access memory).

As the auxiliary memory device 83, for example, a memory device such as an SSD (solid-state drive), an HDD (hard disc drive) or an EEPROM® (electrically erasable programmable read-only memory) can be used, or a combination of these memory devices can be used. In the auxiliary memory device 83, data used by the processor 81 to perform various kinds of processing and data generated in the processing by the processor 81, or the like, are saved. In some cases, the auxiliary memory device 83 may store an application program.

The timepiece 84 functions as a time information source (a clock) for the fraudulent act detection device 22. The processor 81 acquires the current date and time based on time information tracked by the timepiece 84.

The camera interface 85 is an interface for communicating with each camera 21. Captured image data from each camera 21 is received by the fraudulent act detection device 22 via the camera interface 85. The captured image data can be captured video, a captured image or the like of the purchaser operating the self-service POS terminal 11 corresponding to the camera 21.

The communication interface 86 is an interface for performing data communication conforming to a communication protocol with the self-service POS terminal 11, the POS server 12, and the display control device 13 or the like. For example, image data output from the display control device 13 is taken into the fraudulent act detection device 22 via the communication interface 86. The image data is the data of the monitoring image 140 generated on a per self-service POS terminal 11 basis.

In the fraudulent act detection device, a part of the volatile memory area in the main memory 82 is defined as areas for a first buffer 821, a second buffer 822, a threshold table 823, and a threshold memory 824. In the fraudulent act detection device 22, the first buffer 821 on a per self-service POS terminal 11, the second buffer 822 on a per self-service POS terminal 11 basis, the threshold table 823, and the threshold memory 824 are formed in these areas.

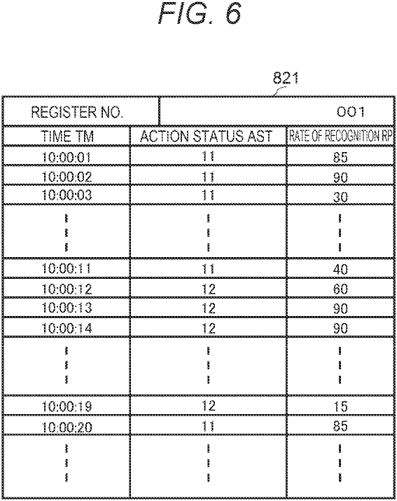

FIG. 6 is a schematic view showing an example of the data structure of the first buffer 821. As shown in FIG. 6, the first buffer 821 is a data buffer that temporarily records the register number identifying the self-service POS terminal 11, time TM, an action status AST, and a rate of recognition RP in correlation with each other.

The time TM is the time of the time point when the action status AST is acquired. The action status AST indicates an action of the purchaser that can be recognized by the action recognition section 221. In this embodiment, the action status AST of the take-out action is defined as “11” and the action status AST of the bagging action is defined as “12”. The rate of recognition RP is the degree to which the action recognition section 221 recognizes the action of the purchaser as the take-out action from the captured image, or the degree to which the action recognition section 221 recognizes the action of the purchaser as the bagging action. The rate of recognition RP is expressed, for example, in percentage. The data items in the first buffer 821 are not limited to the register number, the time TM, the action status AST, and the rate of recognition RP. Other items may be included. The content of text data shown in FIG. 6 is an example.

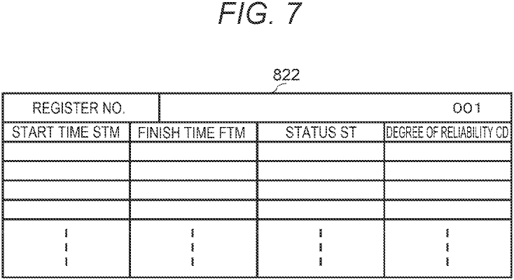

FIG. 7 is a schematic view showing an example of the data structure of the second buffer 822. As shown in FIG. 7, the second buffer 822 is a data buffer that temporarily records the register number identifying the self-service POS terminal 11, start time STM, finish time FTM, a status ST, and a degree of reliability CD in correlation with each other.

The status ST includes an operation status HST and a fraud status IST other than the foregoing action status AST. The operation status HST represents operation information that can be acquired by the operation information acquisition section 223. In this embodiment the operation status HST corresponding to when the operation information of the use start operation is acquired is defined as “21”. The operation status HST corresponding to when the operation information of the merchandise registration operation is acquired is defined as “22”. The operation status HST corresponding to when the operation information of the settlement start operation is acquired is defined as “23”. The fraud status IST represents the state of a fraud indicated by the fraud presumption section 226. In this embodiment, the fraud status IST corresponding to a presumption of fraud with a high degree of reliability is referred to as a first fraud status IST (“31”) and the fraud status IST corresponding to when a presumption of fraud with a low degree of reliability is referred to as a second fraud status IST (“32”).

The start time STM is the time TM of the earliest time point when the action status AST is described in the first buffer 821. The start time STM is also the time of the time point when the operation status HST or the fraud status IST is acquired. The finish time FTM is the time TM of the latest time point when the action status AST is described in the first buffer 821. The degree of reliability CD is the degree of reliability acquired by the degree-of-reliability acquisition section 222, that is, the level of reliability of the recognition of the action of the purchaser by the action recognition section 221. The degree of reliability CD is a numerical value calculated based on the rate of recognition RP. The degree of reliability CD is, for example, in percentage. The degree of reliability CD is an example of the degree of reliability of the recognition of the action of the purchaser.

In the second buffer 822, the status ST and the degree of reliability CD are described in order from the earliest start time STM. In this embodiment, if the action status AST is described as the status ST, the start time STM, the finish time FTM, and the degree of reliability CD are described as well. If the operation status HST or the fraud statue IST is described as the status ST, the start time STM is described as well, but the finish time FTM and the degree of reliability CD are not described. Alternatively, a NULL value is described as the finish time FTM and the degree of reliability CD. The data items in the second buffer 822 are not limited to the register number, the start time STM, the finish time FTM, the status ST, and the degree of reliability CD. Other items may be included.

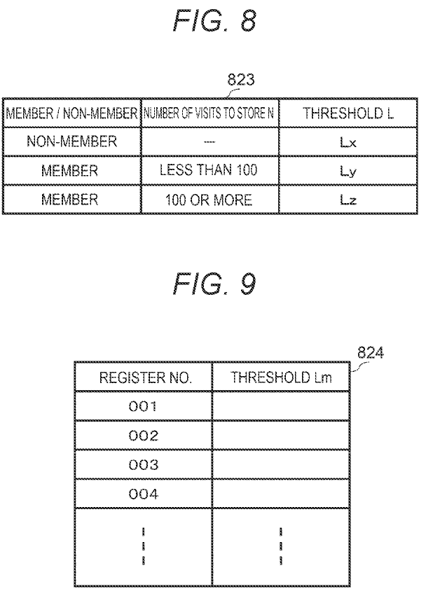

FIG. 8 is a schematic view showing an example of the data structure of the threshold table 823. As shown in FIG. 8, the threshold table 823 is a data table where a threshold L for the degree of reliability CD is set in correlation with the attribute of the purchaser, that is, the information identifying whether the purchaser is a point member or a non-member, and the number of visits to the store N. Specifically, if the attribute of the purchaser is a non-point member, a threshold Lx is set. If the purchaser is a non-point member, the number of visits to the store N is not applicable. If the purchaser is a point member and the number of visits to the store N is less than 100, a threshold Ly is set. If the purchaser is a point member and the number of visits to the store N is 100 or more, a threshold Lz is set.

In this embodiment, the threshold Lx, the threshold Ly, and the threshold Lz are in the relationship of “threshold Lx < threshold Ly < threshold Lz”. That is, for a non-point member, the threshold for the degree of reliability is set to be lower than for a point member with the number of visits to the store N being less than 100. For a point member with the number of visits to the store N of 100 or more, the threshold for the degree of reliability is set to be higher than for the point member with the number of visits to the store being less than 100.

The relevant value of the number of visits to the store N in the threshold table 823 may be set to any value. Alternatively, the number of visits to the store N may be categorized into more than two categories and four or more types of thresholds may be set in the threshold table 823. Also, the number of visits to the store N may be omitted from consideration in some examples.

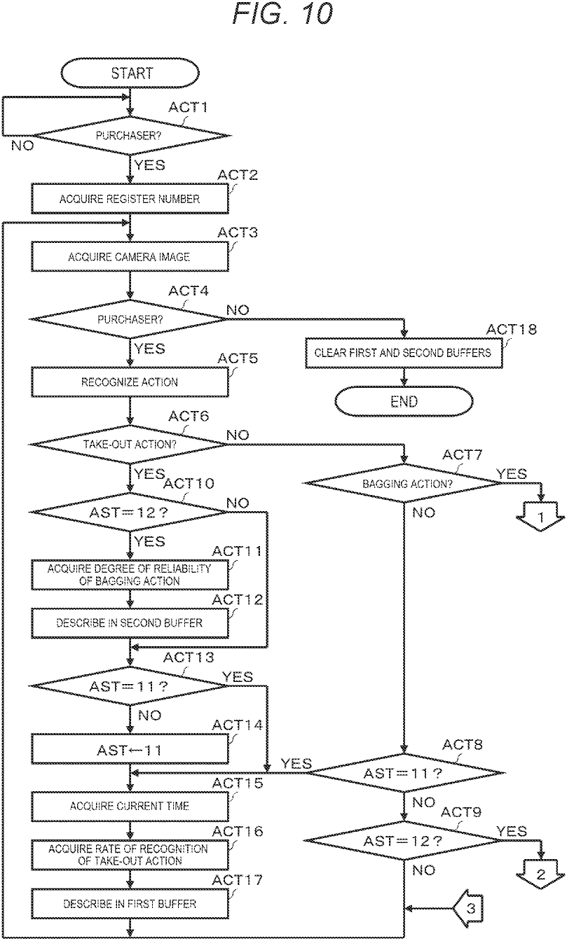

FIG. 9 is a schematic view showing an example of the data structure of the threshold memory 824. As shown in FIG. 9, the threshold memory 824 has an area for storing a threshold Lm in correlation with the register number of each self-service POS terminal 11. In the area of the threshold Lm, one of the threshold Lx, the threshold Ly, and the threshold Lz set in the threshold table 823 is stored.

The processor 81 implements the functions as the action recognition section 221, the degree-of-reliability acquisition section 222, the operation information acquisition section 223, the condition detection section 224, the threshold decision section 225, the fraud presumption section 226, and the output section 227 by information processing executed according to a control program. The control program is a type of application program stored in the main memory 82 or the auxiliary memory device 83. The method for installing the control program in the main memory 82 or the auxiliary memory device 83 is not particularly limited. The control program can be recorded in a removable recording medium or distributed via a network and installed in the main memory 82 or the auxiliary memory device 83. The recording medium may be any form of recording medium that can store a program and be read by a device, such as a CD-ROM or a memory card.

### Description of Functions of Fraudulent Act Detection Device

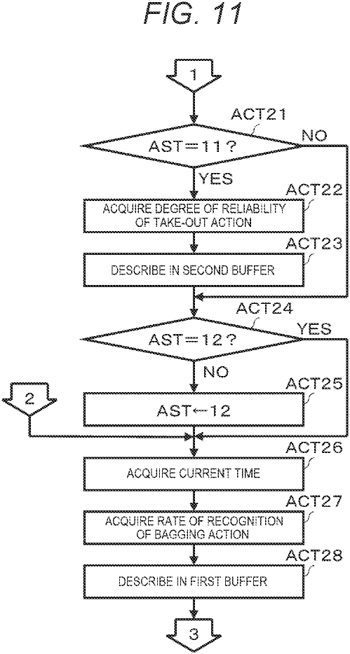

FIGS. 10 to 15 are flowcharts showing main information processing executed by the processor 81 of the fraudulent act detection device 22 according to a control program. Certain functions of a fraudulent act presumption device 22 will now be described using these flowcharts. The described procedures and contents of the functions are only examples. The procedures and contents can be suitably changed, provided that substantially similar effects can be achieved.

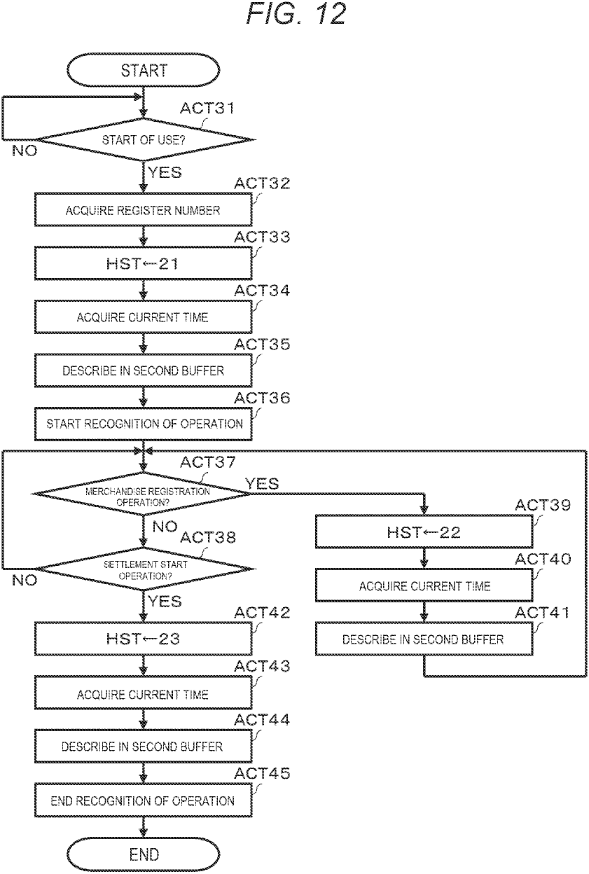

FIGS. 10 and 11 are flowcharts for explaining the operations of the processor 81 as the action recognition section 221 and the degree-of-reliability acquisition section 222.

In ACT 1, the processor 81 waits to recognize a purchaser. The camera 21 is installed at a position where the camera 21 can capture, from above, an image of a purchaser standing in front of the self-service POS terminal 11. Therefore, if the processor 81 detects that a person stands in front of the self-service POS terminal 11 from a captured image captured by the camera 21, the processor 81 determines that a purchaser is recognized.

If the processor 81 recognizes a purchaser in ACT 1, the processor 81 proceeds to ACT 2. In ACT 2, the processor 81 acquires the register number of the self-service POS terminal 11 where a purchaser is recognized. In this example, each camera 21 corresponds one-to-one to a self-service POS terminal 11. Therefore, the processor 81 specifies the self-service POS terminal 1, based on the identification information of the camera 21 capturing an image of a purchaser standing in front of the self-service POS terminal 11, and thus acquires the corresponding register number of the self-service POS terminal 11. The processor 81 defines the first buffer 821 and the second buffer 822 for acquired register number as processing targets.

In ACT 3, the processor 81 acquires an image captured by the camera 21 corresponding to the self-service POS terminal 11 where a purchaser is recognized. Then, in ACT 4, the processor 81 checks whether a person, that is, a purchaser, is shown in the image or not. If a purchaser is shown in the image, the processor 81 proceeds to ACT 5. In ACT 5, the processor 81 recognizes an action of the purchaser. For example, the processor 81 estimates the skeletal structure of joints of the person shown in the image captured by the camera 21 using an AI-based action recognition technology such as deep learning, and attempts to recognize the take-out action and the bagging action of the purchaser based on the movement of estimated skeletal structure.

In ACT 6, the processor 81 checks whether the take-out action of the purchaser is recognized or not. If the take-out action is not recognized, the processor 81 proceeds to ACT 7. In ACT 7, the processor 81 checks whether the bagging action of the purchaser is recognized or not. If the bagging action is not recognized, the processor 81 proceeds to ACT 8. In ACT 8, the processor 81 checks whether the action status AST (“11”) of the take-out action is described along with the latest time in the first buffer 821 that is a processing target, or not. If the action status AST (“11”) of the take-out action is not described in the first buffer 821, the processor 81 proceeds to ACT 9. In ACT 9, the processor 81 checks whether the action status AST (“12”) of the bagging action is described along with the latest time in the first buffer 821 that is a processing target, or not. If the action status AST (“12”) of the bagging action is not described in the first buffer 821, the processor 81 returns to ACT 3.

In this way, in ACT 3 to ACT 9, if “11” and “12” are not described as the action status AST in the first buffer 821, the processor 81 waits until the take-out action or the bagging action of the purchaser shown in the image captured by the camera 21 is recognized.

If the take-out action is recognized in the waiting state in ACT 3 to ACT 9, the processor 81 proceeds from ACT 6 to ACT 10. In ACT 10, the processor 81 checks whether the action status AST (“12”) of the bagging action is described along with the latest time in the first buffer 821 that is a processing target, or not. At this point, the action status AST (“12”) of the bagging action is not described in the first buffer 821. The processor 81 skips the processing of ACT 11 and ACT 12 and proceeds to ACT 13.

In ACT 13, the processor 81 checks whether the action status AST (“11”) of the take-out action is described along with the latest time in the first buffer 821 that is a processing target, or not. At this point, the action status AST (“11”) of the take-out action is not described in the first buffer 821. The processor 81 proceeds to ACT 14. In ACT 14, the processor 81 stores the action status AST (“11”) of the take-out action. Where the action status AST is stored is, for example, a register built in the processor 81.

After finishing the processing of ACT 14, the processor 81 in ACT 15 acquires the current time from the timepiece 84. Also, in ACT 16, the processor 81 acquires the rate of recognition RP of the take-out action. In the description below, the rate of recognition RP of the take-out action is referred to as a rate of recognition RPa. In ACT 17, the processor 81 describes the current time acquired in the processing of ACT 15, the action status AST (“11”) stored in the processing of ACT 14, and the rate of recognition RPa acquired in the processing of ACT 16, in correlation with each other in the first buffer 821 that is a processing target.

Subsequently, the processor 81 returns to ACT 3. Therefore, if the take-out action of the purchaser is recognized again in the next camera image, the processor 81 proceeds from ACT 6 to ACT 10. Again, the action status AST (“12”) of the bagging action is not described with the latest time in the first buffer 821 that is a processing target. Therefore, the processor 81 skips the processing of ACT 11 and ACT 12 and proceeds to ACT 13.

At this point, by the processing of ACT 17, the action status AST (“11”) of the take-out action has been described with the latest time in the first buffer 821 that is a processing target. The processor 81 skips the processing of ACT 14 and proceeds to ACT 15. The processor 81 then executes the processing of ACT 15, ACT 16, and ACT 17 similarly to the above. Thus, in the first buffer 821 that is a processing target, the action status AST (“11”) of the take-out action and the rate of recognition RPa thereof are described in time series in correlation with the time when the take-out action of the purchaser is recognized.

If, for example, a part of the hands of the purchaser is not shown in the camera image and therefore the action of the purchaser is not recognized as the take-out action, and the bagging action is not recognized either, the processor 81 proceeds from ACT 7 to ACT 8. At this point, the action status AST (“11”) of the take-out action has been described with the latest time in the first buffer 821. Therefore, the processor 81 proceeds to ACT 15. The processor 81 then executes the processing of ACT 15, ACT 16, and ACT 17 similarly to the above. Thus, in the first buffer 821, the current time, the action status AST (“11”) indicating the take-out action, and the rate of recognition RPa thereof are described in time series. In this case, the rate of recognition RPa of the take-out action is a lower value than when the take-out action is recognized.

If the bagging action is recognized in the waiting state of ACT 3 to ACT 9, the processor 81 proceeds from ACT 7 to ACT 21 in FIG. 11. In ACT 21, the processor 81 checks whether the action status AST (“11”) of the take-out action is described with the latest time in the first buffer 821 that is a processing target, or not.

When the purchaser begins the bagging action to bag the merchandise to be purchased that is taken out of the basket, the bagging action is recognized in the state where the action status AST (“11”) of the take-out action is described with the latest time. In this way, if the bagging action is newly recognized, the processor 81 proceeds from ACT 21 to ACT 22.

In ACT 22, the processor 81 acquires the degree of reliability of the recognition of the immediately preceding take-out action. For example, the processor 81 searches the first buffer 821 that is a processing target, retrospectively in order from the latest time to the time when the action status AST (“11”) of the take-out action is not described. In the description below, the latest time is defined as the finish time FTM of the take-out action, and the time when the action status AST (“11”) of the take-out action is not described is defined as a pre-start time of the take-out action. The time following the pre-start time is defined as the start time STM of the take-out action. The processor 81 acquires the average value of the rates of recognition of the take-out action from the start time STM to the finish time FTM of the take-out action, as the degree of reliability CD of the recognition of the take-out action. In the description below, the degree of reliability CD of the recognition of the take-out action is referred to as a degree of reliability CDa. In ACT 23, the processor 81 describes the start time STM and the finish time FTM of the take-out action, the action status AST (“11”) of the take-out action, and the degree of reliability CDa of the recognition of the take-out action, in the second buffer 822 that is a processing target.

After finishing the processing of ACT 23, the processor 81 in ACT 24 checks whether the action status AST (“12”) of the bagging action is described with the latest time in the first buffer 821 that is a processing target, or not. At this point, the action status AST (“12”) of the bagging action is not described with the latest time. Therefore, the processor 81 proceeds to ACT 25. In ACT 25, the processor 81 stores the action status AST (“12”) of the bagging action.

After finishing the processing of ACT 25, the processor 81 in ACT 26 acquires the current time from the timepiece 84. In ACT 27, the processor 81 acquires the rate of recognition RP at which the bagging action is recognized by the function of the action recognition section 221. In the description below, the rate of recognition RP at which the bagging action is recognized is referred to as a rate of recognition RPb. In ACT 28, the processor 81 describes the current time acquired in the processing of ACT 26, the action status AST (“12”) of the bagging action stored in the processing of ACT 25, and the rate of recognition RPb acquired in the processing of ACT 27, in correlation with each other in the first buffer 821 that is a processing target.

Subsequently, the processor 81 returns to ACT 3 in FIG. 10. Therefore, if the bagging action of the purchaser is recognized again in the next camera image, the processor 81 proceeds from ACT 7 in FIG. 10 to ACT 21 in FIG. 11. At this point, the action status AST (“12”) of the bagging action has been described with the latest time in the first buffer 821 that is a processing target. Therefore, the processor 81 skips the processing of ACT 22 and ACT 23 and proceeds to ACT 24. The processor 81 also skips the processing of ACT 25 and proceeds to ACT 26. The processor 81 then executes the processing of ACT 26, ACT 27, and ACT 28 similarly to the above. Thus, in the first buffer 821 that is a processing target, the action status AST (“12”) of the bagging action and the rate of recognition RPb thereof are described in time series in correlation with the time when the bagging action of the purchaser is recognized.

If, for example, a part of the hands of the purchaser is not shown in the camera image and therefore the rate of recognition of the bagging action is low and the take-out action is not recognized either, the processor 81 proceeds from ACT 7 to ACT 8 in FIG. 10. At this point, the action status AST (“12”) of the bagging action has been described with the latest time in the first buffer 821 that is a processing target. Therefore, the processor 81 proceeds from ACT 8 to ACT 9 and further proceeds to ACT 26 in FIG. 11. The processor 81 then executes the processing of ACT 26, ACT 27, and ACT 28 similarly to the above. Thus, in the first buffer 821 that is a processing target, the current time, the action status AST (“12”) indicating the bagging action, and the rate of recognition RPb thereof are described in time series. In this case, the rate of recognition RPb of the bagging action is a lower value than when the bagging action is recognized.

When the purchaser finishes the bagging of the merchandise to be purchased and then takes out the next merchandise to be purchased out of the basket, the take-out action is recognized in the state where the action status AST (“12”) of the bagging action is described with the latest time. In this way, if the take-out action of the purchaser is recognized in the waiting state of ACT 3 to ACT 9, the processor 81 proceeds from ACT 6 to ACT 10 and further proceeds to ACT 11. In ACT 11, the processor 81 acquires the degree of reliability of the recognition of the immediately preceding bagging action. For example, the processor 81 searches the first buffer 821 that is a processing target, retrospectively in order from the latest time to the time when the action status AST (“12”) of the bagging action is not described. In the description below, the latest time is defined as the finish time FTM of the bagging action, and the time when the action status AST (“12”) of the bagging action is not described is defined as a pre-start time of the bagging action. The time following the pre-start time is defined as the start time STM of the bagging action. The processor 81 acquires the average value of the rates of recognition of the bagging action from the start time STM to the finish time FTM of the bagging action, as the degree of reliability CD of the recognition of the bagging action. In the description below, the degree of reliability CD of the recognition of the bagging action is referred to as a degree of reliability CDb. In ACT 12, the processor 81 describes the start time STM and the finish time FTM of the bagging action, the action status AST (“12”) of the bagging action, and the degree of reliability CDb of the recognition of the bagging action, in the second buffer 822 that is a processing target.

Subsequently, the processor 81 executes the processing of ACT 13 to ACT 17 similarly to the above. That is, the processor 81 stores the action status AST (“11”) of the take-out action. The processor 81 also describes the current time, the action status AST (“11”) indicating the take-out action, and the rate of recognition RPa of the recognition of the take-out action, in the first buffer 821 that is a processing target.

In this way, if the take-out action of the purchaser is recognized based on the captured image captured by the camera 21, the time of recognition thereof, the action status AST (“11”) of the take-out action, and the rate of recognition RPa of the take-out action are described in the first buffer 821. Then, the processing of describing the time of recognition, the action status AST (“11”), and the rate of recognition RPa in the first buffer 821 is repeated until the bagging action of the purchaser is recognized. If the bagging action of the purchaser is recognized based on the captured image captured by the camera 21, the time of recognition thereof, the action status AST (“12”) of the bagging action, and the rate of recognition RPb of the bagging action are described in the first buffer 821. Then, the processing of describing the time of recognition, the action status AST (“12”), and the rate of recognition RPb in the first buffer 821 is repeated until the next take-out action is recognized.

When the bagging action of the purchaser is newly recognized, the degree of reliability CDa of the recognition of the immediately preceding take-out action is acquired. Then, as a record about the take-out action, the start time STM and the finish time FTM of the take-out action, the action status AST (“11”) of the take-out action, and the degree of reliability CDa are described in the second buffer 822. Similarly, when the take-out action of the purchaser is newly recognized, the degree of reliability CDb of the recognition of the immediately preceding bagging action is acquired. Then, as a record about the bagging action, the start time STM and the finish time FTM of the bagging action, the action status AST (“12”) of the bagging action, and the degree of reliability CDb are described in the second buffer 822.

Normally, the purchaser alternately repeats the take-out action and the bagging action. Therefore, the record about the take-out action and the record about the bagging action are alternately described in the second buffer 822. After bagging the last merchandise to be purchased, the purchaser shifts to the settlement. Therefore, the processor 81 acquires operation information of a settlement start operation by the function of the operation information acquisition section 223 and then executes the processing of ACT 22 and ACT 23 in FIG. 11. Thus, the record about the last bagging action is described in the second buffer 822.

For example, when the purchaser finishes the settlement and moves away from the front of the self-service POS terminal 11, the purchaser is no longer shown in the image captured by the camera 21 corresponding to the self-service POS terminal 11. If the purchaser is no longer shown in the captured image captured by the camera 21 in the waiting state of ACT 3 to ACT 9, the processor 81 proceeds from ACT 4 to ACT 18. In ACT 18, the processor 81 clears the first buffer 821 and the second buffer 822 that are processing targets. The processor 81 then ends the information processing according to the procedures shown in the flowcharts of FIGS. 10 and 11.

In this example, the processor 81 executes the processing of ACT 5 and thus implements the function of the action recognition section 221. The processor 81 also executes the processing of ACT 11 and ACT 22 and thus implements the function of the degree-of-reliability acquisition section 222.

FIG. 12 is a flowchart for explaining the operations of the processor 81 as the operation information acquisition section 223.

In ACT 31, the processor 81 waits until the start of use of the self-service POS terminal 11 is declared. When the start of use is declared, “use started” is shown in the terminal state field 142 in the monitoring image 140 corresponding to this self-service POS terminal 11. The processor 81 checks whether the characters of “use started” can be recognized from the terminal state field 142 in the monitoring image 140 acquired via the display control device 13 or not. If the characters of “use started” are successfully recognized, the processor 81 recognizes that the start of use is declared.

When the processor 81 recognizes that the start of use has been declared, the processor 81 proceeds to ACT 32. In ACT 32, the processor 81 acquires the register number of the self-service POS terminal 11. The register number is shown in the register number field 141 in the monitoring image 140. The processor 81 recognizes the characters of the register number from the register number field 141 in the monitoring image 140 acquired via the display control device 13 and acquires the characters as the register number. The processor 81 defines the second buffer 822 where the acquired register number is described, as a processing target.

After finishing the processing of ACT 32, the processor 81 in ACT 33 stores the operation status HST (“21”) indicating the state where the operation information of the use start operation is acquired. Where the operation status HST is stored is, for example, the register built in the processor 81. In ACT 34, the processor 81 acquires the current time TM tracked by the timepiece 84. Then, in ACT 35, the processor 81 describes the time TM acquired in the processing of ACT 34 and the operation status HST (“21”) stored in the processing of ACT 33, in the second buffer 822 that is a processing target. At this point, the time TM is described as the start time STM.

Therefore, when the purchaser standing in front of the self-service POS terminal 11 performs a declaration operation for the start of use, the operation status HST (“21”) indicating the state where the operation information of the use start operation is acquired is first described along with the time TM in the second buffer 822 corresponding to this self-service POS terminal 11.

After finishing the processing of ACT 35, the processor 81 in ACT 36 starts recognition processing to recognize the operation at the self-service POS terminal 11 identified by the register number acquired in the processing of ACT 32. Specifically, the processor 81 recognizes the merchandise registration operation and the settlement start operation, based on a transition of information acquired by character recognition on the monitoring image 140 acquired via the display control device 13.

In ACT 37, the processor 81 checks whether the merchandise registration operation has been recognized or not. If the merchandise registration operation is not recognized, the processor 81 proceeds to ACT 38. In ACT 38, the processor 81 checks whether the settlement start operation has been recognized or not. If the settlement start operation is not recognized, the processor 81 returns to ACT 37. In this way, in ACT 37 and ACT 38, the processor 81 waits to recognize the merchandise registration operation or the settlement start operation.

If the merchandise registration operation is recognized in the waiting state of ACT 37 and ACT 38, the processor 81 proceeds from ACT 37 to ACT 39. In ACT 39, the processor 81 stores the operation status HST (“22”) indicating the state where the operation information of the merchandise registration operation is acquired. In ACT 40, the processor 81 acquires the current time TM tracked by the timepiece 84. In ACT 41, the processor 81 describes the time TM acquired in the processing of ACT 40 and the operation status HST (“22”) stored in the processing of ACT 39, in the second buffer 822 that is a processing target. At this point, the time TM is described as the start time STM. After finishing the processing of ACT 41, the processor 81 returns to ACT 37.

In this way, when the purchaser having performed the take-out action on the merchandise to be purchased performs the operation to register the merchandise to be purchased at the self-service POS terminal 11, the operation status HST (“22”) indicating the state where the operation information of the merchandise registration operation is acquired is described along with the time TM in the second buffer 822 corresponding to this self-service POS terminal 11. Also, the purchaser having finished the registration operation for the merchandise to be purchased performs the bagging action on the merchandise to be purchased. Therefore, in the second buffer 822, after the action status AST (“11”) of the take-out action, the operation status HST (“22”) of the merchandise registration operation is described and the action status AST (“12”) of the bagging action is subsequently described.

If the settlement start operation is recognized in the waiting state of ACT 37 and ACT 38, the processor 81 proceeds from ACT 38 to ACT 42. In ACT 42, the processor 81 stores the operation status HST (“23”) indicating the state where the operation information of the settlement start operation is acquired. In ACT 43, the processor 81 acquires the current time TM tracked by the timepiece 84. In ACT 44, the processor 81 describes the time TM acquired in the processing of ACT 43 and the operation status HST (“23”) stored in the processing of ACT 42, in the second buffer 822 that is a processing target. At this point, the time TM is described as the start time STM.

Therefore, in the second buffer 822, the operation status HST (“23”) of the settlement start operation is described after the action status AST (“12”) of the bagging action on the merchandise to be purchased that is registered last.

After finishing the processing of ACT 44, the processor 81 in ACT 45 ends the recognition processing for the operation at the self-service POS terminal 11 identified by the register number acquired in the processing of ACT 32. The processor 81 then ends the information processing according to the procedures shown in FIG. 12.

In this example, the processor 81 executes the processing of ACT 36 to ACT 45 and thus implements the functions of the operation information acquisition section 223.

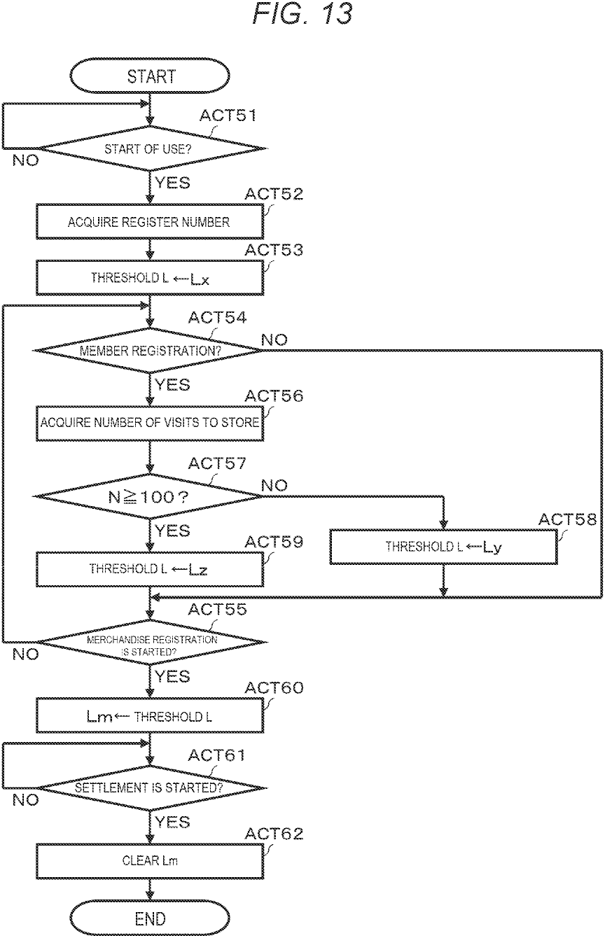

FIG. 13 is a flowchart for explaining the functions of the processor 81 as the condition detection section 224 and the threshold decision section 225.

In ACT 51, the processor 81 waits until the start of use of the self-service POS terminal 11 is declared. When the start of use is declared, “use started” is shown in the terminal state field 142 in the monitoring image 140 corresponding to this self-service POS terminal 11. The processor 81 checks whether the characters of “use started” can be recognized from the terminal state field 142 in the monitoring image 140 acquired via the display control device 13 or not. If the characters of “use started” are successfully recognized, the processor 81 recognizes that the start of use is declared, by the function of the operation information acquisition section 223.

As the processor 81 recognizes that the start of use is declared, the processor 81 proceeds to ACT 52. In ACT 52, the processor 81 acquires the register number of the self-service POS terminal 11. The register number is shown in the register number field 141 in the monitoring image 140. The processor 81 recognizes the characters of the register number from the register number field 141 in the monitoring image 140 acquired via the display control device 13 and acquires the characters as the register number. The processor 81 defines the second buffer 822 where the acquired register number is described, as a processing target.

After finishing the processing of ACT 52, the processor 81 in ACT 53 stores the threshold Lx as a default threshold L. The threshold Lx is the threshold corresponding to the case where the attribute of the purchaser is being a non-point member, as described using FIG. 8. Where the threshold L is stored is the register.

After finishing the processing of ACT 53, the processor 81 in ACT 54 checks whether member registration is performed at the self-service POS terminal 11 or not. If member registration is performed, “member” is shown in the attribute information field 143 in the monitoring image 140. If member registration is not performed, “non-member” remains shown in the attribute information field 143 in the monitoring image 140.

If member registration is not performed, the processor 81 proceeds from ACT 54 to ACT 55. In ACT 55, the processor 81 checks whether merchandise registration is started at the self-service POS terminal 11 or not. When the first merchandise to be purchased is registered at the self-service POS terminal 11, the operation state of the self-service POS terminal 11 turns into the “registration in progress” state. Then, what is shown in the terminal state field 142 in the monitoring image 140 for the self-service POS terminal 11 shifts from “use started” to “registration in progress”. If the characters recognized from the terminal state field 142 in the monitoring image 140 remain “use started”, merchandise registration is not started. The processor 81 returns to ACT 54. In this way, in ACT 54 and ACT 55, the processor 81 waits until member registration is performed or merchandise registration is started.

If the member registration of a point member is performed in the waiting state of ACT 54 and ACT 55, the processor 81 proceeds from ACT 54 to ACT 56. In ACT 56, the processor 81 acquires the number of visits to the store N of the point member. If the member registration of a point member is performed, the number of visits to the store N is shown in the number-of-visits-to-store information field 145 in the monitoring image 140. The processor 81 acquires the number of visits to the store N shown in the number-of-visits-to-store information field 145.

After acquiring the number of visits to the store N of the point member, the processor 81 proceeds to ACT 57. In ACT 57, the processor 81 checks whether the number of visits to the store N is 100 or more, or not. If the number of visits to the store N is less than 100, the processor 81 proceeds from ACT 57 to ACT 58. In ACT 58, the processor 81 updates the default threshold L with the threshold Ly. The threshold Ly is the threshold corresponding to the case where the attribute of the purchaser is being a point member and the number of visits to the store N is less than 100, as described using FIG. 8.

If the number of visits to the store N is 100 or more, the processor 81 proceeds from ACT 57 to ACT 59. In ACT 59, the processor 81 updates the default threshold L with the threshold Lz. The threshold Lz is the threshold corresponding to the case where the attribute of the purchaser is being a point member and the number of visits to the store N is 100 or more, as described using FIG. 8.

After finishing the processing of ACT 58 or ACT 59, the processor 81 proceeds to ACT 55. That is, the processor 81 waits until merchandise registration is started.

If “registration in progress” is recognized from the terminal state field 142 in the monitoring image 140, the processor 81 proceeds from ACT 55 to ACT 60 because merchandise registration has started. In ACT 60, the processor 81 rewrites the threshold Lm in the threshold memory 824 correlated with the register number acquired in the processing of ACT 52, with the threshold L stored in the register. That is, the threshold Lm is the threshold Lx if the attribute of the purchaser is being a non-point member, the threshold Ly if the attribute of the purchaser is being a point member and the number of visits to the store N is less than 100, and the threshold Lz if the attribute of the purchaser is being a point member and the number of visits to the store N is 100 or more.

After finishing the processing of ACT 60, the processor 81 proceeds to ACT 61. In ACT 61, the processor 81 waits until the settlement is started at the self-service POS terminal 11. If a shift to the settlement is declared at the self-service POS terminal 11, the operation state of the self-service POS terminal 11 turns into the “settlement started” state. What is shown in the terminal state field 142 in the monitoring image 140 corresponding to the self-service POS terminal 11 shifts from “registration in progress” to “settlement started”.

The processor 81 waits until the characters recognized from the terminal state field 142 in the monitoring image 140 shift to “use started”. If the characters of “use started” are recognized, the processor 81 proceeds from ACT 61 to ACT 62. In ACT 62, the processor 81 clears the threshold Lm in the threshold memory 824 correlated with the register number acquired in the processing of ACT 52. The processor 81 then ends the information processing according to the procedures shown in the flowchart of FIG. 13.

In this example, the processor 81 executes the processing of ACT 54 to ACT 57 and thus implements the function of the condition detection section 224. The processor 81 also executes the processing of ACT 60 and thus implements the function of the threshold decision section 225.

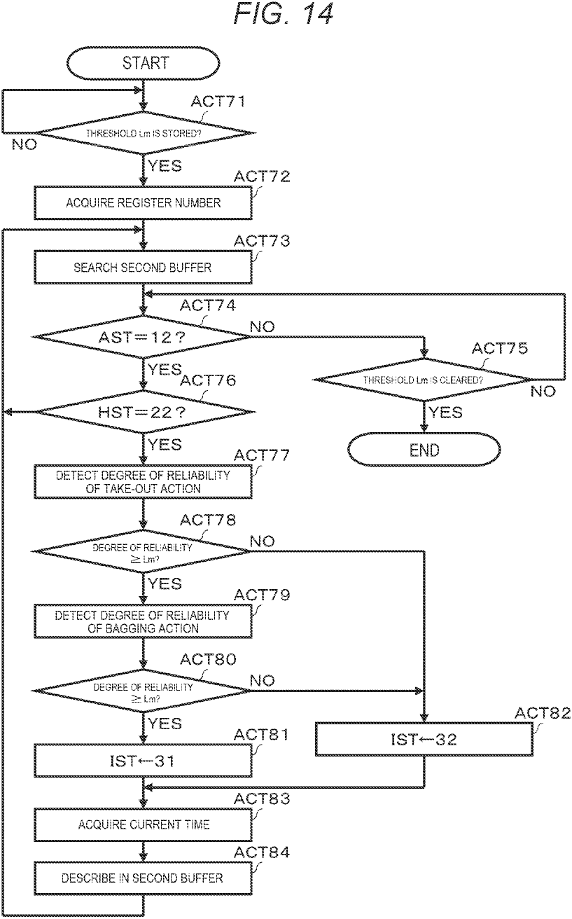

FIG. 14 is a flowchart for explaining the function of the processor 81 as the fraud presumption section 226.

In ACT 71, the processor 81 waits until the threshold Lm is stored in the threshold memory 824. As the threshold Lx, Ly or Lz is stored as the threshold Lm in the threshold memory 824 in ACT 60 in FIG. 13, the processor 81 in ACT 72 acquires the register number correlated with the threshold Lm from the threshold memory 824. In ACT 73, the processor 81 searches the second buffer 822 storing this register number.

In ACT 74, the processor 81 checks whether the action status AST (“12”) of the bagging action is described in the second buffer 822 or not. If the action status AST (“12”) of the bagging action is not described, the processor 81 proceeds to ACT 75. In ACT 75, the processor 81 checks whether the threshold Lm is cleared or not. If the threshold Lm is not cleared, the processor 81 returns to ACT 74. In this way, in ACT 74 and ACT 75, the processor 81 waits until the action status AST (“12”) of the bagging action is described or the threshold Lm is cleared.

If the action status AST (“12”) of the bagging action is described in the second buffer 822 in the waiting state of ACT 74 and ACT 75, the processor 81 proceeds from ACT 74 to ACT 76. The processor 81 checks whether the operation status HST (“22”) of the merchandise registration operation is described immediately before the action status AST (“12”) of the bagging action in the second buffer 822 or not. If the operation status HST (“22”) is described before the action status AST (“12”), the purchaser has put the merchandise to be purchased into the bag after registering the merchandise to be purchased at the self-service POS terminal 11. Therefore, there is no fraudulent act. In this case, the processor 81 returns to ACT 73. The processor 81 searches the second buffer 822 again and waits until the action status AST (“12”) of the bagging action is described or the threshold Lm is cleared.

If the operation status HST (“22”) of the merchandise registration operation is not described immediately before the action status AST (“12”) of the bagging action, the purchaser is presumed to have committed a fraudulent act of putting the merchandise to be purchased into the bag without registering the merchandise to be purchased at the self-service POS terminal 11. In this case, the processor 81 proceeds to ACT 77. In ACT 77, the processor 81 searches the second buffer 822 further and detects the degree of reliability CDa correlated with the action status AST (“11”) of the take-out action described immediately before the action status AST (“12”) of the bagging action. In ACT 78, the processor 81 compares the degree of reliability CDa with the threshold Lm.

If the degree of reliability CDa is equal to or higher than the threshold Lm in ACT 78, the processor 81 proceeds to ACT 79. In ACT 79, the processor 81 searches the second buffer 822 further and detects the degree of reliability CDb correlated with the action status AST (“12”) of the bagging action. In ACT 80, the processor 81 compares the degree of reliability CDb with the threshold Lm.

If the degree of reliability CDb is equal to or higher than the threshold Lm in ACT 80, the processor 81 proceeds to ACT 81. In ACT 81, the processor 81 stores the first fraud status IST (“31”). Where the fraud status IST is stored is, for example, the register built in the processor 81.

If the degree of reliability CDa is lower than the threshold Lm in ACT 78 or if the degree of reliability CDb is lower than the threshold Lm in ACT 80, the processor 81 proceeds to ACT 82. In ACT 82, the processor 81 stores the second fraud status IST (“32”).

After finishing the processing of ACT 81 or ACT 82, the processor 81 in ACT 83 acquires the current time TM tracked by the timepiece 84. In ACT 84, the processor 81 describes the time TM and the fraud status IST stored in the register, in the second buffer 822 that is being searched. The time TM is described as the start time.

Therefore, if both the degree of reliability CDa of the take-out action and the degree of reliability CDb of the bagging action are equal to or higher than the threshold Lm, the processor 81 describes the first fraud status IST (“31”) along with the start time STM in the second buffer 822 that is being searched. If the degree of reliability CDa of the take-out action or the degree of reliability CDb of the bagging action is lower than the threshold Lm, the processor 81 describes the second fraud status IST (“32”) along with the start time STM in the second buffer 822 that is being searched.

After finishing the processing of ACT 84, the processor 81 returns to ACT 73 and continues searching the second buffer 822. Then, if it is confirmed that the action status AST (“12”) of the bagging action is described, the processor 81 executes the processing of ACT 76 to ACT 84 onward, similarly to the above.

If it is confirmed that the threshold Lm is cleared in the waiting state of ACT 74 and ACT 75, the processor 81 ends the information processing according to the procedures shown in the flowchart of FIG. 14.

In this example, the processor 81 executes the processing of ACT 71 to ACT 84 and thus implements the functions of the fraud presumption section 226. Specifically, if the bagging action is recognized without the recognition of the merchandise registration operation on the merchandise to be purchased for which the take-out action was recognized, the processor 81 presumes (detects) this case to be a fraudulent act. At this point, if both the degree of reliability CDa for the recognition of the take-out action immediately before the merchandise registration operation and the degree of reliability CDb for the recognition of the bagging action immediately after the merchandise registration operation are equal to or higher than the threshold Lm, the accuracy of the presumption (detection) of a fraudulent act is high. The processor 81 describes the first fraud status IST (“31”) in the second buffer 822. If the degree of reliability CDa for recognition of the take-out action immediately before the merchandise registration operation or the degree of reliability CDb for recognition of the bagging action immediately after the merchandise registration operation is lower than the threshold Lm, the accuracy of fraudulent act detection is considered to be low. The processor 81 describes the second fraud status IST (“32”) in the second buffer 822.

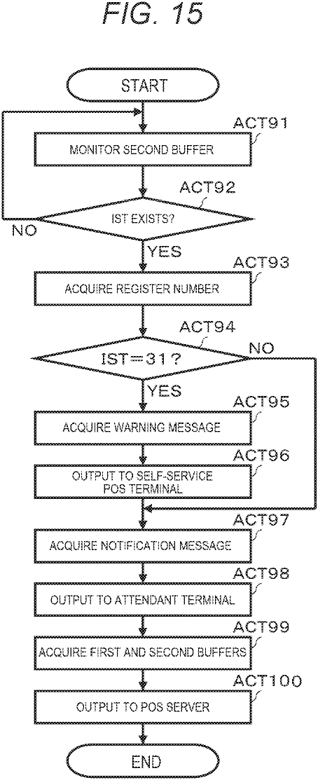

FIG. 15 is a flowchart for explaining the functions of the processor 81 as the output section 227.

In ACT 91, the processor 81 monitors the second buffer 822 on a per self-service POS terminal 11 basis. In ACT 92, the processor 81 checks whether there is a second buffer 822 where the fraud status IST is described, or not. If a second buffer 822 where the fraud status IST is described is detected, the processor 81 proceeds from ACT 92 to ACT 93. In ACT 93, the processor 81 acquires the register number from the second buffer 822.

After finishing the processing of ACT 93, the processor 81 in ACT 94 checks whether the fraud status IST described in the second buffer 822 is the first fraud status IST (“31”) or the second fraud status IST (“32”).

If it is confirmed in ACT 94 that the fraud status IST is the first fraud status IST (“31”), the processor 81 proceeds to ACT 95. In ACT 95, the processor 81 acquires a warning message related to the fraudulent act. The warning message is for the purchaser. For example, a content such as “There is an unregistered merchandise to be purchased” may be employed. In ACT 96, the processor 81 outputs the warning message to the self-service POS terminal 11 identified by the register number acquired in the processing of ACT 93. Consequently, at the self-service POS terminal 11, the warning message is displayed on the touch panel 41. Also, the light-emitting section 65 of the indicator pole 64 emits light in a color indicating that a fraudulent act is occurring. At this point, a warning message may be output from a speaker. Subsequently, the processor 81 proceeds to ACT 97.

If it is confirmed in ACT 94 that the fraud status IST is the second fraud status IST (“32”), the processor 81 skips the processing of ACT 95 and ACT 96 and proceeds to ACT 97. Therefore, if the second fraud status IST (“32”) is described in the second buffer 822, the warning message is not output to the self-service POS terminal 11 corresponding to the register number stored in this second buffer 822.

In ACT 97, the processor 81 acquires a notification message about the fraudulent act. The notification message is for the attendant. For example, a content such as “A fraudulent act may have been committed at the register of register No. X” may be employed. In ACT 98, the processor 81 outputs the notification message to the attendant terminal 14. Consequently, at the attendant terminal 14, the notification message is displayed on the display device. Alternatively, at the attendant terminal 14, a notification message is output from a speaker.

In this way, if the first fraud status IST (“31”) or the second fraud status IST (“32”) is described in the second buffer 822, the notification message is output to the attendant terminal 14.

After finishing the processing of ACT 98, the processor 81 in ACT 99 acquires data of the first buffer 821 and the second buffer 822 storing the register number acquired in the processing of ACT 93. In ACT 100, the processor 81 outputs the data of the first buffer 821 and the second buffer 822 to the POS server 12. The POS server 12 saves the data of the first buffer 821 and the second buffer 822 in the memory device. The processor 81 then ends the information processing according to the procedures shown in the flowchart of FIG. 15.

In this example, the processor 81 executes the processing of ACT 94 to ACT 100 in FIG. 15 and thus implements the function of the output section 227. If the first fraud status IST (“31”) is described in the second buffer 822, the warning message is output to the self-service POS terminal 11 corresponding to the second buffer 822 by the function of the output section 227. Also, the notification message is output to the attendant terminal 14. If the second fraud status IST (“32”) is described in the second buffer 822, the notification message is output to the attendant terminal 14. The warning message is not output to the self-service POS terminal 11 corresponding to the second buffer 822.

### Description of Effects of Fraudulent Act Detection Device

As described, the fraudulent act detection device 22 can indicate an apparent fraudulent act of a purchaser putting the merchandise into a bag without registering the merchandise at the self-service POS terminal 11. However, when the degree of reliability CDa of the recognition of the take-out action and/or the degree of reliability CDb of the recognition of the bagging action is lower than a threshold Lm, the detection/indication of the fraudulent act is not necessarily correct (that is, does not match reality). If the degree of reliability CDa of the recognition of the take-out action or the degree of reliability CDb of the recognition of the bagging action is lower than the threshold Lm, the fraudulent act presumption device 22 does not output a warning message about the fraudulent act to the self-service POS terminal 11. The fraudulent act presumption device 22 only outputs the notification message to the attendant terminal 14. Therefore, the situation where the purchaser finds it unpleasant to be given a warning due to an erroneous determination regarding a normal/proper act based on a recognition with low reliability can be prevented.

Also, the threshold Lm used for the degree of reliability CDa or the degree of reliability CDb is variable according to attributes of the purchaser. Specifically, the threshold Lm for a point member is made higher than for a non-point member. It can be said that a purchaser registered as a point member is typically a person with higher reliability for the store since the point member has previously provided personally identifying information, such as contact information or the like at member registration. Therefore, a warning is not given to such a purchaser unless the action of the purchaser is corresponds to a fraudulent act with a high probability because the threshold Lm is set higher for a point member than for a non-point member. Among point members, the threshold Lm for a member with the number of visits to the store N of 100 or more can be set higher than for a member with the number of visits to the store N of less than 100. It can be considered that a customer with a large number of visits to the store is generally a more important customer to the store than those with fewer visits. Therefore, a warning is not given to such high-visit customers unless the action is corresponds to a fraudulent act with a higher probability than for those with fewer visits.

### Modification Example of Threshold Table

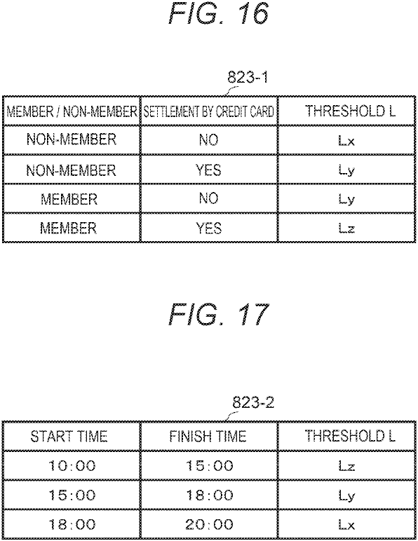

FIG. 16 is a schematic view showing a data structure of a second threshold table 823-1, which is a modification example of the threshold table where an attribute of the purchaser is a condition for change. As shown in FIG. 16, the second threshold table 823-1 is a data table where the threshold L for the degree of reliability CD is set in correlation with information identifying whether the purchaser is a point member or a non-member and information representing whether there is a history of settlement by credit card or not. Specifically, in the case of a condition for change that the attribute of the purchaser is being not a member card holder and having no history of settlement by credit card, a threshold Lx is set. In the case of a condition for change that the attribute of the purchaser is being not a member card holder and having a history of settlement by credit card, a threshold Ly is set. In the case of a condition for change that the attribute of the purchaser is being a member card holder and having no history of settlement by credit card, the threshold Ly is set. In the case of a condition for change that the attribute of the purchaser is being a member card holder and having a history of settlement by credit card, a threshold Lz is set.

The threshold Lx, the threshold Ly, and the threshold Lz are in the relationship of “threshold Lx < threshold Ly < threshold Lz”. That is, the threshold for the purchaser who is not a member card holder and has no history of settlement by credit card is the lowest. The threshold for the purchaser who is not a member card holder and has a history of settlement by credit card or the purchaser who is a member card holder and has no history of settlement by credit card is slightly higher. The threshold for the purchaser who is a member card holder and has a history of settlement by credit card is the highest.

The identity of the purchaser having a history of settlement by credit card can be specified from the credit card. Therefore, this purchaser has higher reliability than the purchaser having no history of settlement by credit card. The threshold for this purchaser is set to be higher and thus reduces fraud presumption errors based on erroneous action recognition. Also, the threshold corresponding to the condition for change that the purchaser is not a member card holder and has a history of settlement by credit card and the threshold corresponding to the condition for change that the purchaser is a member card holder and has no history of settlement by credit card may differ and four levels of threshold may be thus provided.

The attribute of the customer that serves as the condition for change in the threshold may also be a physical feature, appearance or the like of the purchaser. For example, the hands of a tall purchaser tend to enter a blind spot of the camera 21 and therefore an action of this purchaser tends to be erroneously recognized. In this case, the threshold is lowered.

The condition for change in the threshold is not limited to the attribute of the customer. For example, an attribute of the settlement terminal, that is, the self-service POS terminal 11, may be used as the condition for change in the threshold.

FIG. 17 is a schematic view showing a data structure of a third threshold table 823-2, which is a modification example of the threshold table where an attribute of the self-service POS terminal 11 is a condition for change. As shown in FIG. 17, the third threshold table 823-2 is a table where a threshold is set on a per operation time bracket basis of the self-service POS terminal 11. Specifically, a threshold Lz is set corresponding to the start time of 10:00 and the finish time of 15:00 of a first time bracket. A threshold Ly is set corresponding to the start time of 15:00 and the finish time of 18:00 of a second time bracket. A threshold Lx is set corresponding to a third time bracket from the start time of 18:00 to the finish time of 20:00.

The threshold Lx, the threshold Ly, and the threshold Lz are in the relationship of “threshold Lx < threshold Ly < threshold Lz”. The first time bracket is a time bracket during the daytime when the store is relatively not crowded. Therefore, it can be said that the store is in an environment where it is hard to commit a fraudulent act. Thus, the threshold Lz higher than for the other time brackets is set. The second time bracket is a time bracket in the evening when the store is relatively crowded and thus the payment area is crowded. Therefore, it can be said that the store is in an environment where it is easier to commit a fraudulent act. Thus, the threshold Ly lower than for the first time bracket is set. The third time bracket is a time bracket during the night. Therefore, it can be said that the store is in an environment where it is even easier to commit a fraudulent act. Thus, the lowest threshold Lx is set. In this way, as the self-service POS terminal 11 is in an environment where it is easier to commit a fraudulent act, the threshold is lower and therefore a fraudulent act is easier to find. The frequency of occurrence of a fraudulent act corresponding to each time bracket is not limited to this example. For example, a proper threshold may be set on a per store basis.

Also, other factors may be employed as the attribute of the self-service POS terminal 11 that serves as the condition for change in the threshold. For example, in the payment area, there is a self-service POS terminal 11 away from the attendant terminal and a self-service POS terminal 11 near the attendant terminal. At the self-service POS terminal 11 away from the attendant terminal, a fraudulent act is more likely to occur than at the self-service POS terminal 11 near the attendant terminal. Therefore, the threshold for the self-service POS terminal 11 away from the attendant terminal is set to be lower than the threshold for the self-service POS terminal 11 near the attendant terminal.

### Other Modification Examples

In an embodiment, the case where the camera 21 is provided on a per self-service POS terminal 11 basis and captures an image of the purchaser is described as an example. In other examples, one camera 21 may be provided corresponding to two or more self-service POS terminals 11 and may capture an image of the purchasers at each of the self-service POS terminal 11.

In an embodiment, the case where one fraudulent act detection device 22 detects a fraudulent act at a plurality of self-service POS terminals 11 is described as one example. In other examples, a fraudulent act detection device 22 may be provided on a per self-service POS terminal 11 basis. In that case, each self-service POS terminal 11 may itself be equipped to provide each described function of the fraudulent act detection device 22 and thus may a settlement terminal having a fraudulent act detection function be implemented.

The action recognition section 221 need not necessarily use an AI-based action recognition technology such as deep learning. In other examples, actions of the purchaser can be recognized by using a combination of a three-dimensional camera and various sensors such as a light sensor or the like.

The operation information acquisition section 223 may not acquire the operation information from the information shown in the monitoring image 140. For example, an operation input at the self-service POS terminal 11 causes a transition of the image displayed on the touch panel 41 of this self-service POS terminal 11. Therefore, by recognizing the transition of the displayed image the operation information can be acquired. The operation information can also be acquired based on a signal output from the self-service POS terminal 11 to the POS server 12 or the attendant terminal 14.

The fraud presumption section 226 may indicate a fraudulent act without taking the operation information of the purchaser at the self-service POS terminal 11 into account. For example, if an action of the purchaser replacing the merchandise to be purchased with another merchandise after performing the take-out action is captured in the image captured by the camera 21, the occurrence of a fraudulent act may be indicated.

In an embodiment, the average value of the rates of recognition RP from the start time STM to the finish time FTM of the take-out action or the bagging action is employed as the degree of reliability CD. However, the method for calculating the degree of reliability CD is not limited to this. For example, the root mean square of the rates of recognition RP may be employed as the degree of reliability CD. Alternatively, the maximum value of the rates of recognition RP may be employed as the degree of reliability CD.

In an embodiment, the default threshold is Lx. In this respect, another threshold Ly or Lz may be employed as the default threshold in other examples.

While some embodiments have been described, these embodiments are presented simply as examples and are not intended to limit the scope of the present disclosure. These novel embodiments can be carried out in various other forms and can include various omissions, replacements, and modifications without departing from the spirit and scope of the present disclosure. These embodiments and the modifications thereof are included in the scope of the present disclosure and also included in the scope of the claims and equivalents thereof.

What is claimed is:

1. A fraudulent act detection device, comprising:
a camera interface configured to connect to a camera positioned to acquire images of a purchaser at a settlement terminal; and
a processor configured to:
recognize an action of the purchaser at the settlement terminal from an image acquired from the camera via the camera interface;
acquire a degree of reliability for the recognition of the action of the purchaser;
determine whether a change condition for changing a degree of reliability threshold has been met;
set a value for the degree of reliability threshold based on whether or not the change condition has been met; and
use the set value for the degree of reliability threshold in determining whether a fraudulent act of the purchaser has been recognized in acquired images of the purchaser at the settlement terminal.

2. The fraudulent act detection device according to claim 1, further comprising:
a communication interface configured to communicate with an external apparatus, wherein
the processor is further configured to output a notification to the external apparatus via the communication interface after the fraudulent act of the purchaser has been recognized.

3. The fraudulent act detection device according to claim 2, wherein the external apparatus is an attendant terminal.

4. The fraudulent act detection device according to claim 2, wherein the external apparatus is the settlement terminal.

5. The fraudulent act detection device according to claim 1, further comprising:
an operation information acquisition unit configured to acquire operation information of the settlement terminal indicating a present operating state of the settlement terminal, wherein
the operation information is used in determining whether the fraudulent act of the purchaser has been recognized.

6. The fraudulent act detection device according to claim 1, wherein
the change condition is whether the purchaser is a registered member of a rewards point program, and
the value for the degree of reliability threshold is set to a higher level than a default reference value when the purchaser is the registered member.

7. The fraudulent act detection device according to claim 1, wherein the change condition relates to a transaction time attribute or a positional attribute of the settlement terminal.

8. The fraudulent act detection device according to claim 1, wherein
the change condition is related to the number of previous visits by the purchaser, and
the value for the degree of reliability threshold is set to a higher level than a default reference value when the purchaser has more than a predetermined number of previous visits.

9. The fraudulent act detection device according to claim 1, wherein the camera interface is further configured to connect to a plurality of cameras, each camera positioned to acquire images of purchasers at a different one of a plurality of settlement terminals.

10. A fraudulent act detection system, comprising:
a plurality of settlement terminals;
a plurality of cameras positioned to capture images of purchasers at each of the plurality of settlement terminals; and
a fraudulent act detection device including:
a camera interface configured to connect to the plurality of cameras and acquire images from the cameras; and
a processor configured to:
recognize an action of a purchaser at a settlement terminal from an image acquired from one of the plurality of cameras via the camera interface;
acquire a degree of reliability for the recognition of the action of the purchaser;
determine whether a change condition for changing a degree of reliability threshold has been met;
set a value for the degree of reliability threshold based on whether or not the change condition has been met; and
use the set value for the degree of reliability threshold in determining whether a fraudulent act of the purchaser has been recognized in acquired images of the purchaser at the settlement terminal.

11. The fraudulent act detection system according to claim 10, wherein the fraudulent act detection device further includes:
a communication interface configured to communicate with an external apparatus, wherein
the processor is further configured to output a notification to the external apparatus via the communication interface after the fraudulent act of the purchaser has been recognized.

12. The fraudulent act detection system according to claim 11, wherein the external apparatus is an attendant terminal.

13. The fraudulent act detection system according to claim 11, wherein the external apparatus is the settlement terminal.

14. The fraudulent act detection system according to claim 10, wherein
the fraudulent act detection device further includes:
an operation information acquisition unit configured to acquire operation information of the settlement terminal indicating a present operating state of the settlement terminal, and
the operation information is used in determining whether the fraudulent act of the purchaser has been recognized.

15. The fraudulent act detection system according to claim 10, wherein
the change condition is whether the purchaser is a registered member of a rewards point program, and
the value for the degree of reliability threshold is set to a higher level than a default reference value when the purchaser is the registered member.

16. The fraudulent act detection system according to claim 10, wherein the change condition relates to a transaction time attribute or a positional attribute of the settlement terminal.

17. The fraudulent act detection system according to claim 10, wherein
the change condition is related to the number of previous visits by the purchaser, and
the value for the degree of reliability threshold is set to a higher level than a default reference value when the purchaser has more than a predetermined number of previous visits.

18. A fraudulent act detection method comprising:
recognizing an action of a purchaser at a settlement terminal in images of the purchaser at the settlement terminal;
acquiring a degree of reliability for the recognition of the action of the purchaser at the settlement terminal;
determining whether a change condition for a degree of reliability threshold has been met;
setting a value for the degree of reliability threshold based on whether or not the change condition has been met; and
using the set value for the degree of reliability threshold in determining whether a fraudulent act of the purchaser has been recognized in acquired images of the purchaser at the settlement terminal.

19. The method according to claim 18, further comprising:
outputting a notification to an external apparatus via a communication interface after the fraudulent act of the purchaser has been recognized.

20. The method according to claim 19, wherein the external apparatus is at least one of an attendant terminal or the settlement terminal.
